(19) United States
(12) Patent Application Publication
(10) Pub. No.: US 2012/0200082 A1
(43) Pub. Date: Aug. 9, 2012

(54) SOFT PIPE CONNECTING DEVICE

(76) Inventor: Guangren Liang, Guangzhou (CN)

(21) Appl. No.: 13/501,247

(22) PCT Filed: Oct. 11, 2010
(86) PCT No.: PCT/CN2010/077652

§ 371 Date: Apr. 11, 2012

(30) Foreign Application Priority Data
Oct. 12, 2009 (CN) 200920237051.0

(51) Int. Cl. F16L 21/00; F16L 19/00

(52) U.S. Cl. 285/371; 285/398

(57) ABSTRACT

A soft pipe connecting device, comprising: a cylindrical joint, a fixed sleeve inside the joint for supporting the joint, and an outer ring sheathed outside the soft pipe and tightly pressing the soft pipe against the outer wall surface of the joint. The outside wall surface of the cylindrical joint is provided in sequence with a limit baffle, a groove and plurality of pawls whose tooth-tips are oriented towards the groove. The outer ring is made of expandable material. The inside wall surface of the outer ring is provided with a projection on the position corresponding to that of the groove of the joint, and plurality of reverse pawls whose positions correspond to those of the pawls of the joint. The groove may be provided therein with a sealing ring. The sealing effect is very good and can effectively prevent the leakage of gas or liquid.

### FIELD OF THE INVENTION

The present invention relates to a connecting device, and more specifically to a connecting device connected to the soft pipes or soft pipe and rigid pipe between.

### BACKGROUND OF THE INVENTION

At present, we adopt connecting device to joint soft pipes and rigid pipes. Usually, the connection manner between the soft pipe and connecting device is to paste the soft pipe on the joint of the connecting device, and fasten the soft pipe with metal or plastic lanterning ring, or to fit the soft pipe over the joint and fasten it with clip which give the pressure to change the shape of the wall of soft pipe and fix the soft pipe. However, for the valid time of glue and the possibility of crevice, the former manner is, relatively complex and prone to gas or liquor leakage. And the later manner can be limited that, when the wall of soft pipe is thin such as below 0.16 CM, its shape will change little under the pressure of clip which situation may causes the leakage of gas or liquid. It might be worse when the connection position between soft pipe and joint is short and narrow.

### SUMMARY OF THE INVENTION

In order to overcome the disadvantages of the prior art, the present invention provides a soft pipe connecting device that is connection closely, sealing well, easy to operate.

To achieve these goals, the present invention provides a soft pipe connecting device, comprising: a cylindrical joint, a fixed sleeve inside the joint for supporting the joint, and an outer ring sheathed outside the soft pipe and tightly pressing the soft pipe against the outer wall surface of the joint. The outside wall surface of the cylindrical joint is provided in sequence with a limit baffle, a groove and plurality of pawls whose tooth-tips are oriented towards the groove. The outer ring is made of expandable material. The inside wall surface of the outer ring is provided with a projection on the position corresponding to that of the groove of the joint, and plurality of reverse pawls whose positions correspond to those of the pawls of the joint. Under the normal state, a diameter of the outer ring is less than a diameter of the cylindrical joint, under the external force, the outer ring expands and a deformed diameter of the outer ring is greater than the diameter of the cylindrical joint, the soft pipe can be sheathed on the outer wall surface of the joint, after connection, the projection is in the groove, the pawls of the cylindrical joint and the pawls that is in the inner wall surface of the outer ring are mutually engaged.

The case may be preferred for the following program:

the groove may be provided therein with a sealing ring to enhance the seal of the soft pipe and the joint;

the outer ring is made from plastic or metal;

the material of the outer ring is preferable to nylon;

the shape of the fixed sleeve is preferable to circular, with a hole in the center of the fixed sleeve which air and liquid can through.

The invention utilizes the pawls of the outer ring pressed the pawls of the joint, in order to achieve the sealing purpose, especially for the surface is not smooth enough, the unevenness of the thickness of the soft pipe.

When used, the outer ring is sleeved on the soft pipe, the soft pipe is sheathed on the joint, and then through the external mechanical force, the outer ring is pulled to the direction of the joint, the outer ring radial expands deformation by the external force, extrudes and crosses the pawls of the joint, until the projection of the outer ring falls into the groove of the joint, at the same time, the pawls of the joint and the pawls of the outer ring are engaged mutually, clamps in the concave ring of the soft pipe to prevent the soft pipe fall from the joint effectively. In order to enhance the sealing effect between the joint and the soft pipe, the groove has the sealing ring. The limit baffle of the joint can effectively prevent the joint and the soft pipe slide to the limit baffle direction, generate gap.

Through the above structure design, the connected tightness between the thin-walled soft pipe and the joint are improved, sealing better, effectively preventing the leakage of gas and liquid, moreover, simple and convenient for installation, more practical.

### DESCRIPTION OF THE DRAWINGS

FIG. 1 is an exploded view of the first embodiment in accordance with the present invention;

FIG. 2 is a structural diagram of the first embodiment of the of FIG. 1 after the installation in accordance with the present invention;

FIG. 3 is an enlargement diagram of the A-A part of FIG. 2 in accordance with the present invention;

FIG. 4 is an exploded view of the second embodiment in accordance with the present invention;

FIG. 5 is a structural diagram of the second embodiment of the of FIG. 4 after the installation in accordance with the present invention;

FIG. 6 is an enlargement diagram of the B-B part of FIG. 5 in accordance with the present invention.

### DETAILED DESCRIPTION OF THE INVENTION

The following illustrations are further explanations of the invention, with the instructions of the figures.

### The First Embodiment

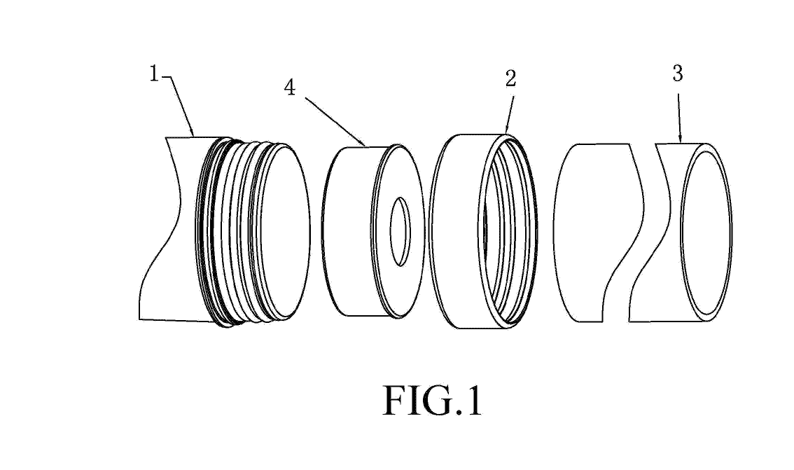

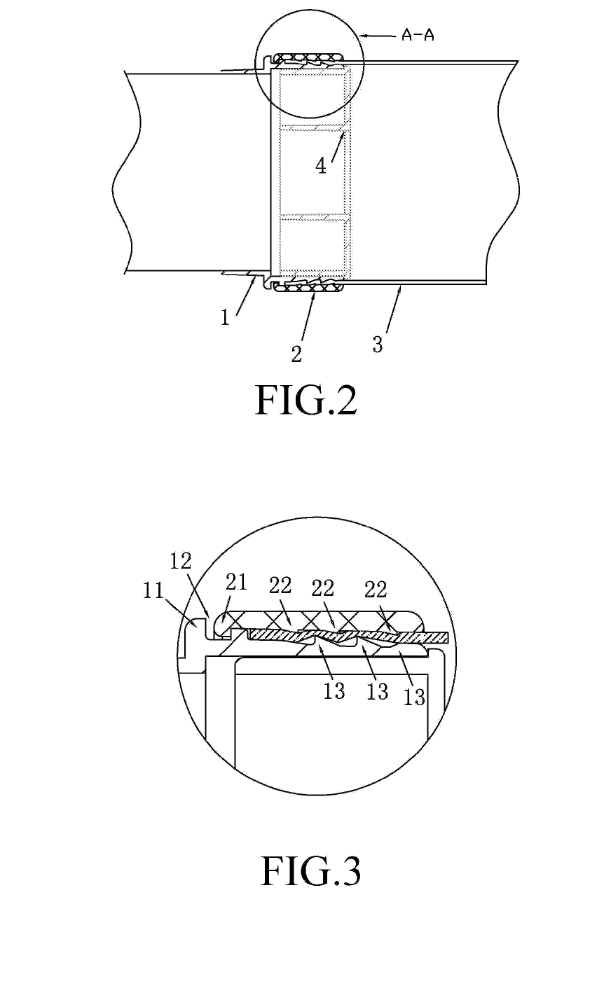

Referring to FIGS. 1-3, the first embodiment of the soft pipe connecting device, comprises a cylindrical joint 1, an outer ring 2, and a fixed sleeve 4. The fixed sleeve 4 is inside the joint 1 for supporting the joint 1, when the outer ring 2 that is sheathed on the joint 1 generates of radial pressure to the joint 1 to prevent the joint 1 radial deformation. The outside wall surface of the cylindrical joint 1 is provided in sequence with a limit baffle 11, a groove 12. and two pawls 13 whose tooth-tips are oriented towards the groove 12. The outer ring 2 is made of expandable material, such as plastic or metal, the embodiment is preferable to nylon, the inside wall surface of the outer ring 2 is provided with a projection 21 on the position corresponding to that of the groove 12 of the joint 1, and two reverse pawls 22 whose positions correspond to the two pawls 13 of the joint 1. Under the normal state, the diameter of the outer ring 2 is less than the diameter of the joint 1.

When used, the outer ring 2 is sleeved on the soft pipe 3, the soft pipe 3 is sheathed on the joint 1, and then through the external mechanical force, the outer ring 2 is pulled to the direction of the joint 1, the outer ring 2 radial expands deformation by the external force, extrudes and crosses the pawls 13 of the joint 1, until the projection 21 of the outer ring 2 falls into the groove 12 of the joint 1, at the same time, the pawls 13 of the joint 1 and the pawls 22 of the outer ring 2 are engaged mutually, clamps in the concave ring of the soft pipe 3 to prevent the soft pipe 3 fall from the joint 1 effectively. Therefore, the limit baffle 11 of the joint 1 can effectively prevent the joint 1 and the soft pipe 3 slide to the limit baffle 11 direction, generate gap, avoid the leakage of gas and liquid.

### The Second Embodiment

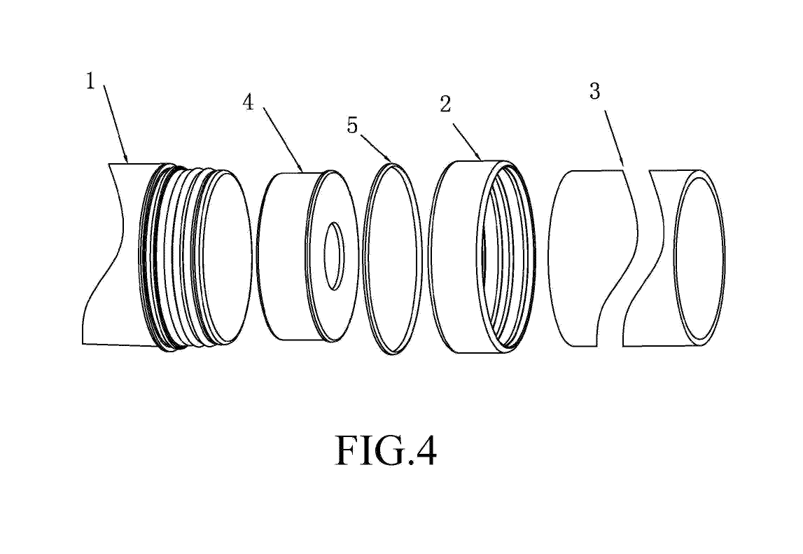

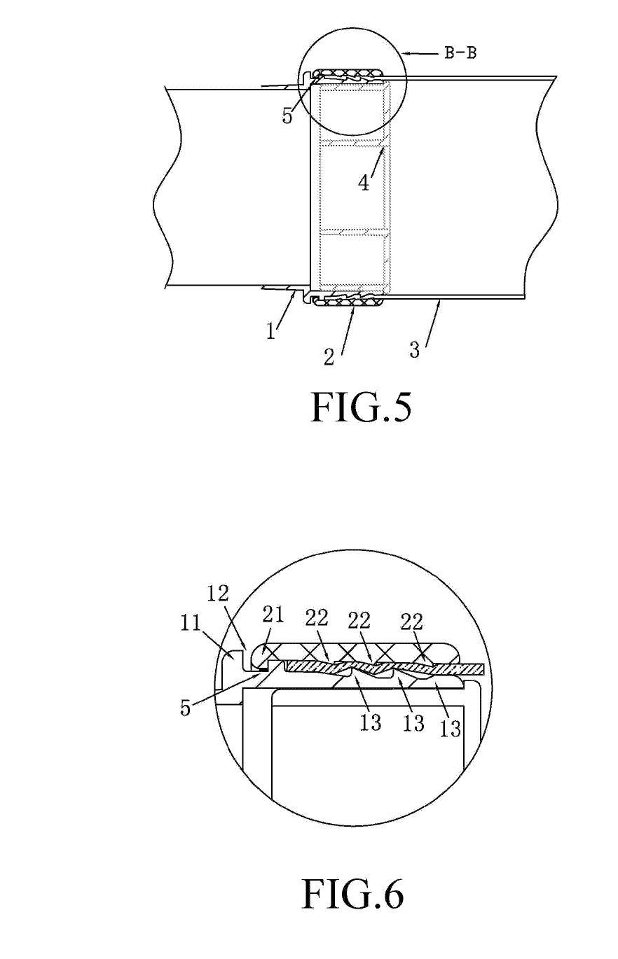

Referring to FIGS. 4-6, the structure of the second embodiment and the first embodiment are basically the same. On the basis of the first embodiment, adding the sealing ring 5, which is in the groove 12 of the joint 1, can enhance the connection sealing effect between the soft pipe 3 and the joint 1.

It should be noted that, the present invention is mainly in accordance of a soft pipe connecting device. Any structure and mounting method relates to this invention is in the scope of the invention protection issues. While the present invention has been illustrated by the above description of the preferred embodiments thereof. while the preferred embodiments have been described in considerable detail, it is not intended to restrict or in any way limit the scope of the appended claims to such details. Other advantages and modifications within the spirit and scope of the present invention will readily appear to those skilled in the art. Therefore, the present invention is not limited to the specific details and the illustrative examples shown and described.

What is claimed is:

1. A soft pipe connecting device, wherein, comprising:
a cylindrical joint, an outside wall of the cylindrical joint provided in sequence with a limit baffle, a groove and plurality of pawls whose tooth-tips are oriented towards the groove;
a fixed sleeve inside the joint for supporting the joint;
the expandable outer ring sheathed on the out of the soft pipe to press the soft pipe on the outer wall surface of the joint, the inside wall surface of the outer ring provided with a projection on the position corresponding to that of the groove of the joint, and plurality of reverse pawls whose positions correspond to those of the pawls of the joint;
under the normal state, a diameter of the outer ring is less than a diameter of the cylindrical joint, under the external force, the outer ring expands and a deformed diameter of the outer ring is greater than the diameter of the cylindrical joint, the soft pipe can be sheathed on the outer wall surface of the joint, after connection, the projection is in the groove, the pawls of the cylindrical joint and the pawls that is in the inner wall surface of the outer ring are mutually engaged.

2. The soft pipe connecting device of claim 1, wherein the groove is provided therein with a sealing ring.

3. The soft pipe connecting device of claim 1, wherein the outer ring is made from plastic or metal.

4. The soft pipe connecting device of claim 3, wherein the outer ring is made from nylon.

5. The soft pipe connecting device of claim 1, wherein the fixed sleeve is circular, with a hole in the center of the fixed sleeve.
